(19) United States
(12) Patent Application Publication
(10) Pub. No.: US 2024/0210652 A1
(43) Pub. Date: Jun. 27, 2024

(54) Membrane Assembly for Optics in a Virtual Reality (VR) Display Device

(71) Applicant: Meta Platforms Technologies, LLC, Menlo Park, CA (US)

(72) Inventors: Joel Bernard JACOBS, Seattle, WA (US); Jeffrey Taylor STELLMAN, Seattle, WA (US); Joseph Patrick SULLIVAN, Seattle, WA (US)

(21) Appl. No.: 18/505,439

(22) Filed: Nov. 9, 2023

Related U.S. Application Data
(60) Provisional application No. 63/476,408, filed on Dec. 21, 2022.

(51) Int. Cl. G02B 7/12

(52) U.S. Cl. CPC G02B 7/12

(57) ABSTRACT

Aspects of the present disclosure are directed to a membrane assembly including a flexible membrane that seals an interior of a head-mounted display device from foreign objects and foreign materials. The head-mounted display device can be a virtual reality (VR) head-mounted display device. The membrane assembly can include a flexible membrane and bezels attached to the flexible membrane, and configured to be attached to a frame and optics modules of the head-mounted display device. The flexible membrane is configured to extend around lenses respectively mounted in the optics modules. The optics modules can be configured to move in the frame to change and interpupillary distance (IPD) of the lenses. An inner surface of the flexible membrane includes surface deviations configured to deform when the optics modules move, thereby allowing the flexible membrane to deform, without impeding movement of the optics modules, while sealing the interior of the head-mounted display device.

### CROSS-REFERENCE TO RELATED APPLICATION(S)

This application claims priority to U.S. Provisional Application No. 63/476,408 filed on Dec. 21, 2022 and currently pending, having Attorney Docket No. 3589-0173PV01, titled “Membrane Assembly for Optics in a Virtual Reality (VR) Display Device” which is incorporated herein by reference in its entirety.

### TECHNICAL FIELD

The present disclosure is directed to a membrane assembly for optics in a head-mounted display device (e.g., a virtual reality (VR) display device), and a display device assembly including the membrane assembly.

### BACKGROUND

Virtual reality (VR) display devices have become increasingly popular due to their ability to implement applications, such as gaming applications, that deliver immersive and interactive audiovisual experiences. For example, a conventional VR display device is configured to be secured on a user's face over the user's eyes, and includes a pair of optics modules including respective lenses configured to pass the stereoscopic images therethrough from a screen of the VR display device. The optics modules can be disposed inside of a frame in an interior space of the VR headset. To prevent interior components of the VR display device from being contaminated, damaged, or otherwise functionally interfered with by foreign objects and foreign materials, it is important to provide a sealing member that surrounds the lenses and seals the interior of the VR display device.

Additionally, in some VR display devices, the optics modules are moveable to move the lenses to adjust an interpupillary distance (IPD) of the lenses. In a VR display device including moveable optics modules, it is important to seal the interior of the device from foreign objects and foreign materials while allowing movement of the optics modules.

### BRIEF DESCRIPTION OF THE DRAWINGS

FIG. 1 is a perspective view showing a head-mounted display device including a membrane assembly attached to a frame and first and second optics modules, in accordance with an embodiment.

FIGS. 2A and 2B are perspective and top plan views, respectively, showing the frame and the first and second optics modules of FIG. 1, wherein the first and second optics modules are in positions corresponding to a first interpupillary distance (IPD).

FIGS. 3A and 3B are perspective and top plan views, respectively, showing the frame and the first and second optics modules of FIG. 2, wherein the first and second optics modules are in positions corresponding to a second IPD.

FIG. 4 is a perspective view showing the membrane assembly of FIG. 1.

FIG. 5A is another perspective view showing the membrane assembly of FIG. 1.

FIG. 5B is an exploded perspective view of the membrane assembly of FIG. 1.

FIGS. 6A and 6B are perspective views showing a flexible membrane, in accordance with an embodiment.

FIG. 7 is a perspective view of a head-mounted display device, in accordance with an embodiment.

The features and aspects introduced here may be better understood by referring to the following Detailed Description in conjunction with the accompanying drawings, in which like reference numerals indicate identical or functionally similar elements. The drawings may not be to scale, and the relative size, proportions, and depiction of elements in the drawings may be exaggerated for clarity, illustration, and convenience.

### DETAILED DESCRIPTION

Aspects of the present disclosure are directed to a membrane assembly including a flexible membrane configured to seal an interior of a head-mounted display device from foreign objects and foreign materials. The head-mounted display device can be a virtual reality (VR) display device, for example. The membrane assembly can include a flexible membrane, and bezels attached to the flexible membrane and configured to be attached to a frame and optics modules of the head-mounted display device. The flexible membrane is configured to extend around lenses respectively mounted in the optics modules. The optics modules can be configured to move in the frame to change and interpupillary distance (IPD) of the lenses. An inner surface of the flexible membrane includes surface deviations configured to deform when the optics modules move, thereby allowing the flexible membrane to deform, without impeding movement of the optics modules, while sealing the interior of the head-mounted display device.

Other aspects of the present disclosure are directed to a head-mounted display device assembly including the membrane assembly, the frame, and the optics modules.

According to embodiments described herein, a membrane assembly for a head-mounted display device can include a flexible membrane configured to be attached to a frame of the head-mounted display device. The flexible membrane can include: a first lens opening configured to accommodate a first lens of the head-mounted display device; a second lens opening configured to accommodate a second lens of the head-mounted display device; a perimeter portion disposed around the first and second lens openings; a central portion disposed between the first and second lens openings; at least one first deviating surface feature disposed around the first lens opening; and at least one second deviating surface feature disposed around the second lens opening. The at least one first deviating surface feature can be configured to change in shape in response to displacement of first inner edge portions of the flexible membrane that define the first lens opening. The at least one second deviating surface feature can be configured to change in shape in response to displacement of second inner edge portions of the flexible membrane that define the second lens opening.

In some embodiments, the membrane assembly can further include an outer bezel attached to an outer edge portion of the flexible membrane and configured to be attached to a frame of the head-mounted display device.

In some embodiments, the outer bezel can be attached to the flexible membrane by a snap fit or a press fit.

In some embodiments, the outer bezel can be molded with the flexible membrane.

In some embodiments, the outer bezel can be constructed of a material that is more rigid than a material of which the flexible membrane is constructed.

In some embodiments, the outer bezel can include a perimeter portion supporting the perimeter portion of the flexible membrane and central portion supporting the central portion of the flexible membrane.

In some embodiments, the membrane assembly can further include: a first optics mounting bezel attached to the first inner edge portions of the flexible membrane, and configured to be attached to a first optics module including the first lens; and a second optics mounting bezel attached to the second inner edge portions of the flexible membrane, and configured to be attached to a second optics module including the second lens.

In some embodiments, the first and second optics mounting bezels can be attached to the flexible membrane by a snap fit or a press fit.

In some embodiments, the first and second optics bezels can be molded with the flexible membrane.

In some embodiments, the at least one first deviating surface feature can include a first depression disposed on an inner surface of the flexible membrane in the perimeter portion, and extending around the first lens opening. The at least one second deviating surface feature includes a second depression disposed on the inner surface of the flexible membrane in the perimeter portion, and extending around the second lens opening.

In some embodiments, the at least one first deviating surface feature can further include a first convex portion disposed on an outer surface of the flexible membrane, and corresponding to the first depression. The at least one second deviating surface feature further can include a second convex portion disposed on the outer surface of the flexible membrane, and corresponding to the second depression.

In some embodiments, the membrane assembly can further include a third concave depression disposed on the inner surface of the flexible membrane, in the central portion, and configured to accommodate a user's nose.

In some embodiments, the at least one first deviating surface feature can further include a first protruding pleat disposed on the inner surface of the flexible membrane, between the first lens opening and the central portion. The at least one second deviating surface feature can further include a second protruding pleat disposed on the inner surface of the flexible membrane, between the second lens opening and the central portion.

In some embodiments, the at least one first deviating surface feature can further include a first recessed pleat disposed on an outer surface of the flexible membrane, and corresponding to the first protruding pleat. The at least one second deviating surface feature can further include a second recessed pleat disposed on the outer surface of the flexible membrane, and corresponding to the second protruding pleat.

According to embodiments described herein, an assembly for a head-mounted display device can include: a frame configured to be installed in an outer case of the head-mounted display device; a first optics module including a first lens, and configured to be mounted to the frame; a second optics module including a second lens, and configured to be mounted to the frame; and a flexible membrane configured to be attached to the frame. The flexible membrane can include: a first lens opening configured to accommodate the first lens; a second lens opening configured to accommodate the second lens; at least one first deviating surface feature disposed around the first lens opening, and at least one second deviating surface feature disposed around the second lens opening. The first and second optics modules can be configured to move to change an interpupillary distance between the first and second lenses. The at least one first deviating surface feature can be configured to change in shape in response to movement of the first optics module to change the interpupillary distance. The at least one second deviating surface feature can be configured to change in shape in response to movement of the second optics module to change the interpupillary distance.

In some embodiments, the frame can include: a main body configured to be attached to the outer case; a first inner ring disposed in a space within the main body; and a second inner ring disposed in the space within the main body and spaced apart from the first inner ring. The first and second optics modules can be configured to be mounted in the first and second inner rings, respectively. The flexible membrane can further include: an outer bezel attached to an outer edge portion of the flexible membrane and configured to be attached to the main body of the frame; a first optics mounting bezel attached to first inner edge portions of the flexible membrane that define the first lens opening, and configured to be attached to the first optics module; and a second optics mounting bezel attached to second inner edge portions of the flexible membrane that define the second lens opening, and configured to be attached to the second optics module.

In some embodiments, the at least one first deviating surface feature can include a first depression disposed on an inner surface of the flexible membrane in a perimeter portion of the flexible membrane, and extending around the first lens opening. The at least one second deviating surface feature can include a second depression disposed on the inner surface of the flexible membrane in the perimeter portion, and extending around the second lens opening.

In some embodiments, the at least one first deviating surface feature can further include a first protruding pleat disposed on the inner surface of the flexible membrane, between the first lens opening and a central portion of the flexible membrane. The at least one second deviating surface feature can further include a second protruding pleat disposed on the inner surface of the flexible membrane, between the second lens opening and the central portion of the flexible membrane.

According to embodiments described herein, a head-mounted display device can include: an outer case; a frame disposed in the outer case; a first optics module mounted to the frame and including a first lens; a second optics module mounted to the frame and including a second lens; and a flexible membrane attached to the frame. The flexible membrane can include: a first lens opening accommodating the first lens; a second lens opening accommodating the second lens; at least one first deviating surface feature disposed around the first lens opening; and at least one second deviating surface feature disposed around the second lens opening. The first and second optics modules can be configured to move to change an interpupillary distance between the first and second lenses. The at least one first deviating surface feature can be configured to change in shape in response to movement of the first optics module to change the interpupillary distance. The at least one second deviating surface feature can be configured to change in shape in response to movement of the second optics module to change the interpupillary distance.

In some embodiments, the at least one first deviating surface feature can include a first depression disposed on an inner surface of the flexible membrane in a perimeter portion of the flexible membrane, and extending around the first lens opening. The at least one second deviating surface feature can include a second depression disposed on the inner surface of the flexible membrane in the perimeter portion, and extending around the second lens opening.

In some embodiments, the at least one first deviating surface feature can include a first protruding pleat disposed on an inner surface of the flexible membrane, between the first lens opening and a central portion of the flexible membrane. The at least one second deviating surface feature can include a second protruding pleat disposed on the inner surface of the flexible membrane, between the second lens opening and the central portion of the flexible membrane.

Several embodiments are discussed below in more detail in reference to the figures.

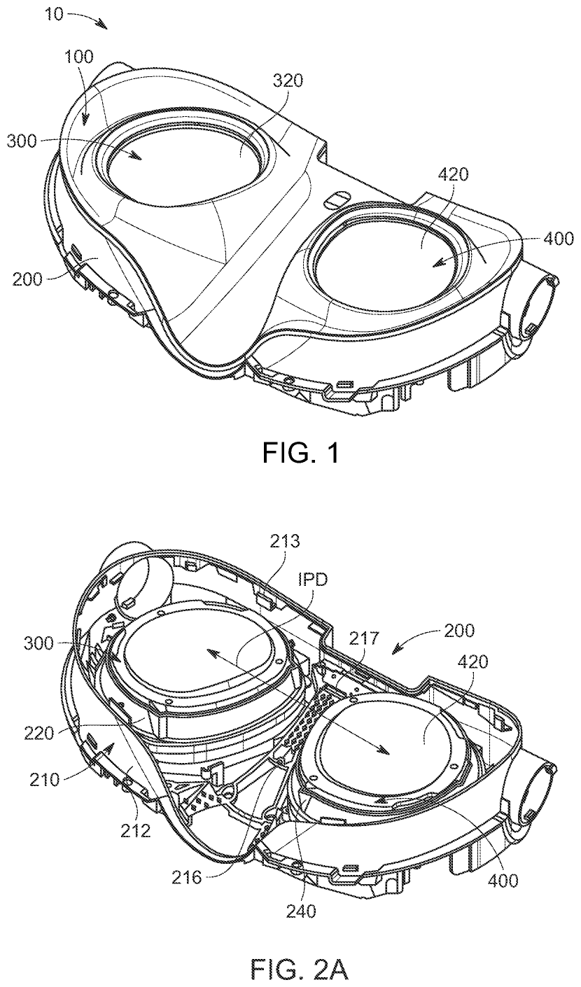

FIG. 1 is a perspective view of display device assembly 10 for a head-mounted display device. The display device assembly 10 includes internal structural and functional components of the head-mounted display device. For example, the display device assembly 10 can be a virtual reality (VR) display device assembly for a head-mounted VR display device that is configured to be secured on a user's face over the user's eyes.

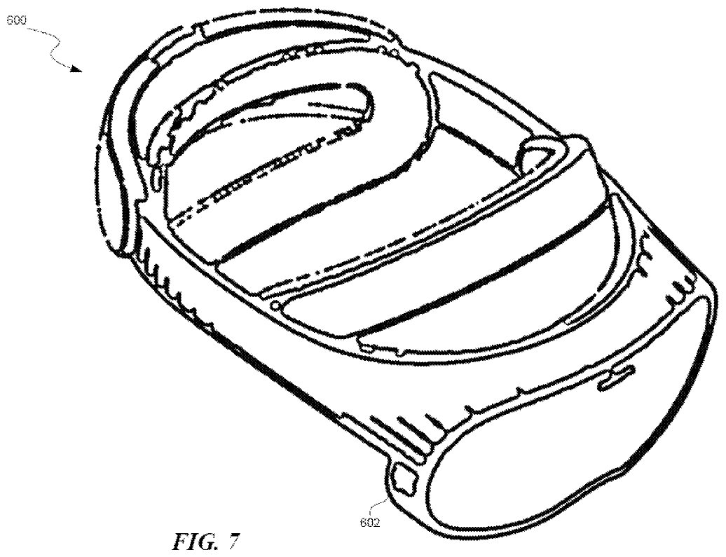

Referring to FIG. 1, the display device assembly 10 includes a membrane assembly 100, a frame 200, a first (e.g., left) optics module 300 and a second (e.g., right) optics module 400. The display device assembly 10 can be inserted in and connected to an outer case or housing of the head-mounted display device, such as an outer case 602 of a head-mounted display device 600 shown in FIG. 7.

The first and second optics modules 300 and 400 include a first (e.g., left) lens 320 and a second (e.g., right) lens 420, respectively. The first and second lenses 320 and 420 are configured to respectively pass first and second (e.g., left and right) images therethrough from a screen of the head-mounted display device. For example, the first and second lenses 320 and 420 can be stereoscopic lenses configured to present a stereoscopic image to the user.

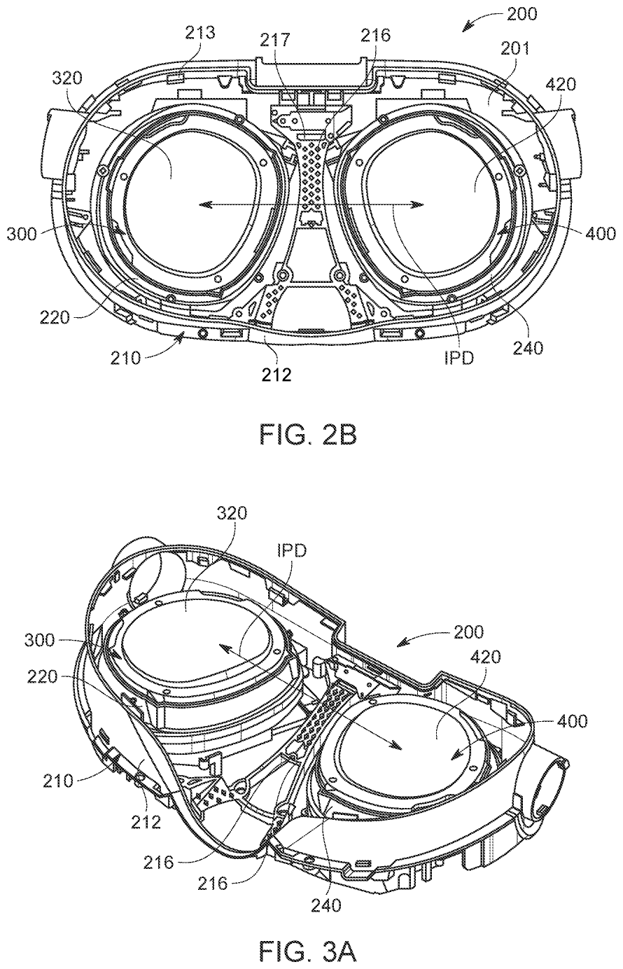

FIGS. 2A and 2B are perspective and top plan views, respectively, showing the frame 200 and the optics modules 300 and 400, wherein the first and second optics modules 300 and 400 are in positions corresponding to a first interpupillary distance (IPD) between the first and second lenses 320 and 420. More specifically, FIGS. 2A and 2B show inner sides of the frame 200 and the optics modules 300 and 400, which face the user's face when the head-mounted display device is secured to the user's face.

As shown in FIGS. 2A and 2B, the frame 200 includes a main body or outer ring 210, a first (e.g., left) inner ring 220, and a second (e.g., right) inner ring 240. The outer ring 210 is configured to be attached to the outer case or housing of the head-mounted display device, and includes perimeter portion 212 and central portion 216. In some embodiments, the perimeter portion 212 can have an oval shape, as shown. However, in other embodiments, the perimeter portion 212 can have a rectangular shape. The central portion 216 extends between opposing portions of the perimeter portion 212 at a central region of the outer ring 210 and generally corresponds to the position of a nose of the user when the head-mounted display device is secured to the user's face.

The first and second inner rings 220 and 240 have an annular shape and are disposed in an interior space 201 inside of the outer ring 210, which is an internal space of the display device assembly 10 and the head-mounted display device when the frame 200 is installed in the head-mounted display device. As shown in FIGS. 2A and 2B, the first inner frame 220 is disposed in the interior space 201 at a first (e.g., left) side thereof, between the perimeter portion 212 and the central portion 216 of the outer ring 210. The second optics module frame 220 is disposed in the interior space 201 at a second (e.g., right) side thereof, between the outer perimeter portion 212 and the central portion 216 of the outer ring 210.

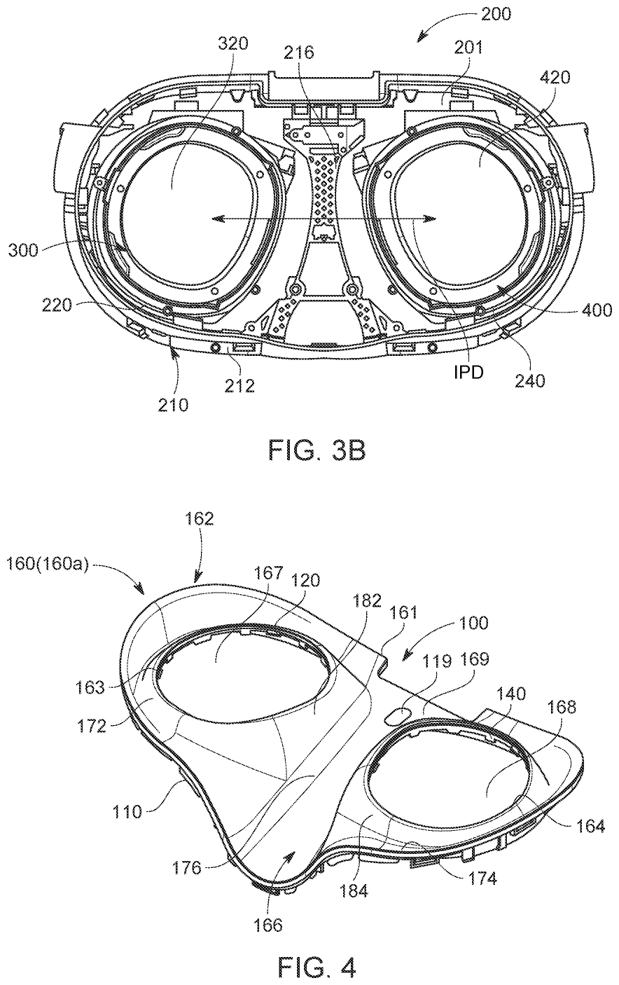

The first and second optics modules 300 and 400 are mounted in the first and second inner frames 220 and 240, respectively. As described above, in FIGS. 2A and 2B, the first and second inner frames 220 and 240 are positioned such that there is a first IPD between the first and second lenses 320 and 420. In some embodiments, to optimize image viewing for a variety of users, the first and second inner frames 220 and 240 can be moveably mounted such that they are moveable to change the IPD. More specifically, in such embodiments, the first and second inner frames 220 and 240 can be moved to move the first and second optics modules 300 and 400, respectively, and thereby change the IPD. For example, the first IPD shown in FIGS. 2A and 2B can be a minimum IPD, and the first and second optics modules 300 and 400 can be moved to various positions between the position corresponding to the first IPD and a position corresponding to a second, maximum IPD shown in FIGS. 3A and 3B. In some embodiments, the IPD can be adjustable in a range of 58 mm to 72 mm.

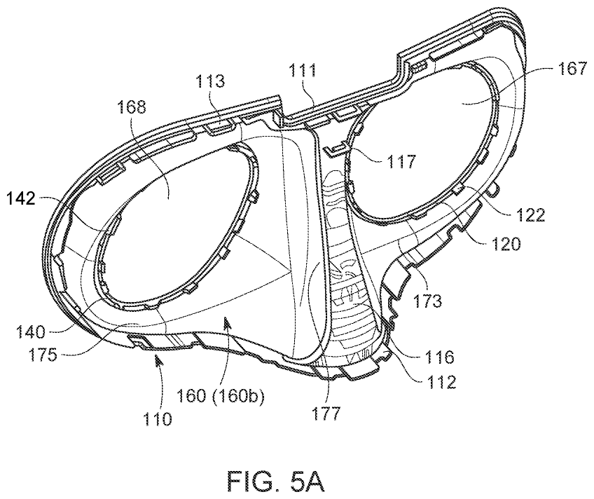

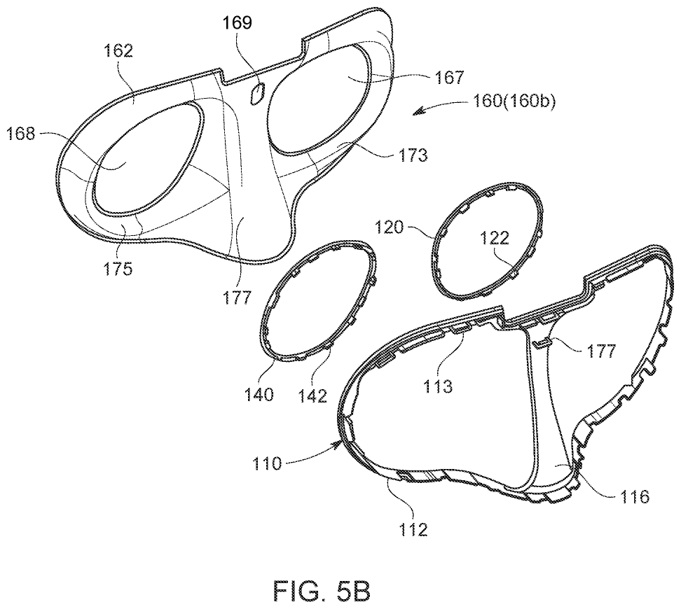

FIG. 4 is a perspective view showing the membrane assembly 100. FIG. 5A is another perspective view showing the membrane assembly 100. FIG. 5B is an exploded perspective view of the membrane assembly 100. In the view of FIG. 4, an inner side of the membrane assembly 100, which is configured to face the user's face, is shown. In the views of FIGS. 5A and 5B, an outer side of the membrane assembly 100, which is configured to face the frame 200, is shown.

Referring to FIGS. 4, 5A, and 5B, the membrane assembly 100 includes an outer bezel 110, a first optics mounting bezel 120, a second optics mounting bezel 140, and a flexible membrane 160. The outer bezel 110 and the first and second optics mounting bezels 120 and 140 are formed of a rigid material, such as polycarbonate or a similarly rigid material. The flexible membrane 160 is formed of a thin, flexible, molded material, such as silicone or another elastomer such as, but not limited to, rubber. In some embodiments, the outer bezel 110 and the flexible membrane 160 have respective shapes corresponding to each other and the shape of the outer ring 210.

For example, the flexible membrane 160 includes a perimeter portion 162 forming an inclined outer wall, and a central portion 166 extending between opposite sides of the perimeter portion 162. The flexible membrane 160 further includes a first (e.g., left) lens opening 167 and a second (e.g., right) lens opening 168 defined between the perimeter portion 162 and the central portion 166. The first and second lens openings 167 and 168 are configured to surround edge portions of the first and second lenses 320 and 420, respectively, such that the first and second lenses 320 and 420 are exposed to eyes of the user through the first and second lens openings 167 and 168. The central portion 166 of the flexible membrane 160 is configured to accommodate the user's nose. The perimeter portion 162 and the central portion 166 of the flexible membrane 160 are configured to surround the eyes of the user and the first and second optics modules 300 and 400.

As shown in FIG. 4, the flexible membrane 160 has a contoured inner surface 160a that includes deviating surface features configured to accommodate the user's face and the first and second optics modules 300 and 400, and enable the flexible membrane to deform when the first and second optics modules 300 and 400 move to adjust the IPD. More specifically, first and second valleys (e.g., concave depressions) 172 and 174 are disposed on the inner surface 160a around the first and second lens openings 167 and 168, respectively, in regions between the first and second lens openings 167 and 168 and an outer edge portion 161 of the flexible membrane 160. The first valley 172 can be semi-annular shaped and is disposed in the perimeter portion 162, between the outer edge portion 161 of the flexible membrane 160 and a first elevated annular wall 182 surrounding the first lens opening 167. The second valley 174 can be semi-annular shaped and is disposed in the perimeter portion 162, between the outer edge portion 161 of the flexible membrane 160 and a second elevated annular wall 184 surrounding the second lens opening 168. A third valley 176 is disposed on the inner surface 160a in the central portion 166 of the flexible membrane 160. The third valley 176 is configured to accommodate the user's nose, and the first and second annular walls 182 and 184 are configured to extend around the first and second optics modules 300 and 400, respectively.

As shown in FIG. 5B, the flexible membrane 160 has a contoured outer surface 160b that includes sculpted features, or deviating surface features, corresponding to the sculpted features of the inner surface 160a. More specifically, first and second convex portions 173 and 175 are disposed on the outer surface 160b around the first and second lens openings 167 and 168, respectively, at regions corresponding to the regions of the first and second valleys 172 and 174, respectively, on the inner surface 160a. A third convex portion 177 is disposed on the outer surface 160b in the central portion 166 of the flexible membrane 160 at a region corresponding to the region of the third valley 176 on the inner surface 160a.

Referring to FIGS. 4, 5A, and 5B, the outer bezel 110 includes a perimeter portion 112 and a central portion 116 extending between opposite sides of the perimeter portion 112. The perimeter portion 112 of the outer bezel 110 corresponds to the perimeter portion 162 of the flexible membrane 160 and the central portion 116 of the outer bezel 110 corresponds to the central portion 166 of the flexible membrane 160. As shown in FIGS. 5B, 2A, and 2B, the outer bezel 110 includes a plurality of protrusions 113 on the perimeter portion 112 that are configured to engage corresponding retaining members 213 on the perimeter portion 212 of the outer ring 210, and a protrusion 117 on the central portion 116 that is configured to engage a retaining member 217 on the central portion 216 of the outer ring 210.

In some embodiments, the first and second optics mounting bezels 120 and 140 have shapes corresponding to the boundaries of the first and second lens openings 167 and 168, respectively. The first and second optics mounting bezels 120 and 140 have respective protrusions 122 and 142 that are configured to engage the first and second optics modules 300 and 400, respectively.

FIGS. 4 and 5A show the membrane assembly 100 in an assembled state in which the flexible membrane 160 is attached to the outer bezel 110, the first optics mounting bezel 120, and the second optics mounting bezel 140. As shown in FIGS. 4 and 5A, when the membrane assembly 100 is in the assembled state, the outer bezel 110, the first optics mounting bezel 120, and the second optics mounting bezel 140 are disposed on the second surface 160b of the flexible membrane 160. The outer edge portion 161 of the flexible membrane 160 is secured to an outer edge portion 111 of the outer bezel 110 such that the perimeter portion 112 of the outer bezel 110 supports the perimeter portion 162 of the flexible membrane 160. The central portion 166 of the flexible membrane 160 is secured to the central portion 116 of the outer bezel 110 by a tab 119 of the central portion 116 of the outer bezel 110 that is inserted into a hole 169 in the central portion 166 of the flexible membrane 160. Further, the membrane assembly 100 is in the assembled state, the first and second optics mounting bezels 120 and 140 are respectively secured to first and second inner edge portions 163 and 164 of the flexible membrane 160 that surround the first and second lens openings 167 and 168, respectively.

The outer bezel 110, the first optics mounting bezel 120, the second optics mounting bezel 140, and the flexible membrane 160 can be assembled together in various ways. For example, in some embodiments, the outer bezel 110, the first optics mounting bezel 120, and the second optics mounting bezel 140 can be insert-molded (e.g., in an injection molding tool or a compression molding tool) with the flexible membrane 160. In some embodiments, the outer bezel 110, the first optics mounting bezel 120, and the second optics mounting bezel 140 can be two-shot molded with the flexible membrane 160. In some embodiments, the outer bezel 110, the first optics mounting bezel 120, and the second optics mounting bezel 140 can be attached to the flexible membrane 160 with adhesive after each of these parts is molded. Additionally, in some embodiments, the outer bezel 110, the first optics mounting bezel 120, and the second optics mounting bezel 140 can be clamped or otherwise secured in place on the flexible membrane 160, after each of these parts is molded, by a snap fit, a press fit, or fasteners. When the outer bezel 110, the first optics mounting bezel 120, the second optics mounting bezel 140, and the flexible membrane 160 are assembled together in any of the ways described above, the resulting membrane assembly 100 includes the flexible membrane 160 with rigid substrate features (e.g., the outer bezel 110, the first optics mounting bezel 120, the second optics mounting bezel 140) that allow the membrane assembly 100 to be assembled to the head-mounted display device.

Referring back to FIG. 1, when the membrane assembly 100 is assembled with the frame 200 and the first and second optics modules 300 and 400, the outer bezel 110 can be secured to the outer ring 210 by a snap fit provided by engagement of the protrusions 113 and 117 of the outer bezel 110 with the retaining members 213 and 217 of the outer ring 210, respectively. Additionally, the first and second optics mounting bezels 120 and 140 can be secured to the first and second optics modules 300 and 400 by snap fit provided by engagement of the protrusions 122 and 142 of the first and second optics mounting bezels 120 and 140, respectively, with the first and second optics modules 300 and 400, respectively.

The flexibility of the material forming the flexible membrane 160 and the excess amount of material provided by the first, second, and third valleys 172, 174, and 178 and the corresponding first, second, and third convex portions 173, 175, and 177 enable the flexible membrane 160 to deform while remaining securely attached to the outer ring 210 and the first and second optics modules 300 and 400. That is, as the first and second optics modules 300 and 400 move to change the IPD, the inner edge portions 163 and 164 of the flexible membrane 160 are displaced and, in response, the first, second, and third valleys 172, 174, and 178 and the corresponding first, second, and third convex portions 173, 175, and 177 change in shape to accommodate the movement of the first and second optics modules 300 and 400. Therefore, the flexible membrane 160 seals the interior space 201 without restricting movement of the first and second optics modules 300 and 400 when the IPD is adjusted.

To reduce the appearance of wrinkles at extreme IPD settings of the optics modules 300 and 400, the flexible membrane 160 can have a textured surface. Additionally, a coating can be applied to the inner surface 160a of the flexible membrane 160 to provide improved comfort for portions of the user's face that contact the inner surface 160a.

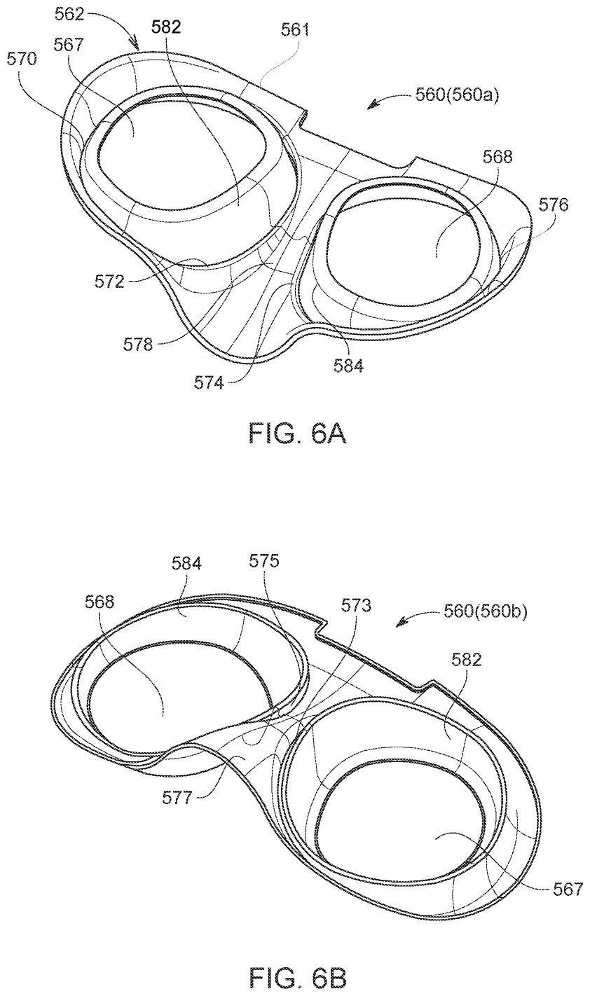

FIGS. 6A and 6B are perspective views showing a flexible membrane 560, in accordance with an embodiment. The flexible membrane 560 can be used in place of the flexible membrane 160. The flexible membrane 560 is similar to the flexible membrane 160, except that an inner surface 560a of the flexible membrane 560 has deviating surface features that are different from those of the inner surface 160a of the flexible membrane 160 and an outer surface 560b of the flexible membrane 560 has deviating surface features that are different from those of the outer surface 160b of the flexible membrane 160.

As shown in FIG. 6A, first and second valleys (e.g., recessed channels) 570 and 576 are disposed on the inner surface 560a around first and second lens openings 567 and 568, respectively, in regions between the first and second lens openings 167 and 168 and an outer edge portion 561 of the flexible membrane 560. The first valley 570 can be semi-annular shaped and is disposed in a perimeter portion 562, between the outer edge portion 561 of the flexible membrane 560 and a first elevated annular wall 582 surrounding the first lens opening 567. The second valley 576 can be semi-annular shaped and is disposed in the perimeter portion 562, between the outer edge portion 561 of the flexible membrane 160 and a second elevated annular wall 584 surrounding the second lens opening 568.

A third valley 578 is formed on the inner surface 560a in a central portion 566 of the flexible membrane 560. A first protruding pleat or bellows (e.g., convex fold) 572 is disposed on the inner surface 560a between the third valley 578 and the first elevated annular wall 582 surrounding the first lens opening 567, and a second protruding pleat or bellows 574 is disposed on the inner surface 560a between the third valley 578 and the second elevated annular wall 584 surrounding the second lens opening 568. The first and second valleys 570 and 576 transition to the first and second pleats 572 and 574, respectively, in areas adjacent to the central portion 566.

As shown in FIG. 6B, a convex portion 577 is formed on the outer surface 560b in the central portion 566 of the flexible membrane 560. A first recessed pleat or bellows (e.g., concave fold) 573 is disposed on the outer surface 560b between the convex portion 577 and the annular wall 582 surrounding the first lens opening 567, in a region corresponding to a region in which the first protruding pleat 572 is disposed. A second recessed pleat or bellows 575 is disposed on the outer surface 560b between the convex portion 577 and the annular wall 584 surrounding the second lens opening 568, in a region corresponding to a region in which the second protruding pleat 574 is disposed.

The first and second valleys 570 and 576 disposed on the inner surface 560a, the first and second pleats 572 and 574 disposed on the inner surface 560a, and the first and second pleats 573 and 575 disposed on the outer surface 560b are configured to deform when the first and second optics modules 300 and 400 move and displace inner edge portions 563 and 564 that define the first and second lens openings 567 and 568, respectively. In addition to enabling the flexible membrane 560 to deform without inhibiting movement of the first and second optics modules 300 and 400, the pleats 572, 573, 574, and 575 mitigate the formation of unsightly wrinkles on the inner surface 560a.

According to the embodiments described herein, a membrane assembly effectively seals an interior space of a head-mounted display device to prevent foreign objects and substances from entering the interior space and thereby damaging or negatively impacting the performance of optical components of the head-mounted display device. Additionally, a flexible membrane of the membrane assembly includes deviating surface portions that are configured to deform when optics modules of the head-mounted display device are moved to adjust an IPD of lenses in the optics modules, such that the membrane assembly is deformable and does not impede movement of the optics modules. Further, the flexible membrane provides a comfortable surface for contacting a user's face during operation of the head-mounted display device.

Reference in this specification to “embodiments” (e.g., “some embodiments,” “various embodiments,” “one embodiment,” “an embodiment,” etc.) means that a particular feature, structure, or characteristic described in connection with the embodiment is included in at least one embodiment of the disclosure. The appearances of these phrases in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “includes” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Although the subject matter has been described in language specific to structural features and/or methodological acts, it is to be understood that the subject matter defined in the appended claims is not necessarily limited to the specific features or acts described above. Specific embodiments have been described herein for purposes of illustration, but various modifications can be made without deviating from the scope of the embodiments. The specific features and acts described above are disclosed as example forms of implementing the claims that follow. Accordingly, the embodiments are not limited except as by the appended claims.

Any patents, patent applications, and other references noted above are incorporated herein by reference. Aspects can be modified, if necessary, to employ the systems, functions, and concepts of the various references described above to provide yet further embodiments. If statements or subject matter in a document incorporated by reference conflicts with statements or subject matter of this application, then this application shall control.

We claim:

1. A membrane assembly for a head-mounted display device, the membrane assembly comprising:
a flexible membrane configured to be attached to a frame of the head-mounted display device, the flexible membrane including:
a first lens opening configured to accommodate a first lens of the head-mounted display device,
a second lens opening configured to accommodate a second lens of the head-mounted display device,
a perimeter portion disposed around the first and second lens openings,
a central portion disposed between the first and second lens openings,
at least one first deviating surface feature disposed around the first lens opening, and
at least one second deviating surface feature disposed around the second lens opening,
wherein the at least one first deviating surface feature is configured to change in shape in response to displacement of first inner edge portions of the flexible membrane that define the first lens opening, and
wherein the at least one second deviating surface feature is configured to change in shape in response to displacement of second inner edge portions of the flexible membrane that define the second lens opening.

2. The membrane assembly of claim 1, further comprising:
an outer bezel attached to an outer edge portion of the flexible membrane and configured to be attached to a frame of the head-mounted display device.

3. The membrane assembly of claim 2, wherein the outer bezel is attached to the flexible membrane by a snap fit or a press fit.

4. The membrane assembly of claim 2, wherein the outer bezel is molded with the flexible membrane.

5. The membrane assembly of claim 2, wherein the outer bezel is constructed of a material that is more rigid than a material of which the flexible membrane is constructed.

6. The membrane assembly of claim 2, wherein the outer bezel includes a perimeter portion supporting the perimeter portion of the flexible membrane and central portion supporting the central portion of the flexible membrane.

7. The membrane assembly of claim 1, further comprising:
a first optics mounting bezel attached to the first inner edge portions of the flexible membrane, and configured to be attached to a first optics module including the first lens; and
a second optics mounting bezel attached to the second inner edge portions of the flexible membrane, and configured to be attached to a second optics module including the second lens.

8. The membrane assembly of claim 7, wherein the first and second optics mounting bezels are attached to the flexible membrane by a snap fit or a press fit.

9. The membrane assembly of claim 7, wherein the first and second optics bezels are molded with the flexible membrane.

10. The membrane assembly of claim 1, wherein:
the at least one first deviating surface feature includes a first depression disposed on an inner surface, opposite an outer surface, of the flexible membrane in the perimeter portion, and extending around the first lens opening; and
the at least one second deviating surface feature includes a second depression disposed on the inner surface of the flexible membrane in the perimeter portion, and extending around the second lens opening.

11. The membrane assembly of claim 10, wherein:
the at least one first deviating surface feature further includes a first convex portion disposed on the outer surface of the flexible membrane, and corresponding to the first depression; and
the at least one second deviating surface feature further includes a second convex portion disposed on the outer surface of the flexible membrane, and corresponding to the second depression.

12. The membrane assembly of claim 10, further comprising:
a third concave depression disposed on the inner surface of the flexible membrane, in the central portion, and configured to accommodate a user's nose.

13. The membrane assembly of claim 10, wherein:
the at least one first deviating surface feature further includes a first protruding pleat disposed on the inner surface of the flexible membrane, between the first lens opening and the central portion; and
the at least one second deviating surface feature further includes a second protruding pleat disposed on the inner surface of the flexible membrane, between the second lens opening and the central portion.

14. The membrane assembly of claim 13, wherein:
the at least one first deviating surface feature further comprises a first recessed pleat disposed on the outer surface of the flexible membrane, and corresponding to the first protruding pleat; and
the at least one second deviating surface feature further comprises a second recessed pleat disposed on the outer surface of the flexible membrane, and corresponding to the second protruding pleat.

15. An assembly for a head-mounted display device, the assembly comprising:
a frame configured to be installed in an outer case of the head-mounted display device;
a first optics module including a first lens, and configured to be mounted to the frame;
a second optics module including a second lens, and configured to be mounted to the frame; and
a flexible membrane configured to be attached to the frame and including:
a first lens opening configured to accommodate the first lens,
a second lens opening configured to accommodate the second lens,
at least one first deviating surface feature disposed around the first lens opening, and
at least one second deviating surface feature disposed around the second lens opening,
wherein the first and second optics modules are configured to move to change an interpupillary distance between the first and second lenses,
wherein the at least one first deviating surface feature is configured to change in shape in response to movement, of the first optics module, to change the interpupillary distance, and
wherein the at least one second deviating surface feature is configured to change in shape in response to movement, of the second optics module, to change the interpupillary distance.

16. The assembly of claim 15, wherein:
the frame includes:
a main body configured to be attached to the outer case,
a first inner ring disposed in a space within the main body, and
a second inner ring disposed in the space within the main body and spaced apart from the first inner ring;
the first and second optics modules are configured to be mounted in the first and second inner rings, respectively; and
the flexible membrane further includes:
an outer bezel attached to an outer edge portion of the flexible membrane and configured to be attached to the main body of the frame,
a first optics mounting bezel attached to first inner edge portions of the flexible membrane that define the first lens opening, and configured to be attached to the first optics module, and
a second optics mounting bezel attached to second inner edge portions of the flexible membrane that define the second lens opening, and configured to be attached to the second optics module.

17. The assembly of claim 15, wherein:
the at least one first deviating surface feature includes a first depression disposed on an inner surface of the flexible membrane in a perimeter portion of the flexible membrane, and extending around the first lens opening; and
the at least one second deviating surface feature includes a second depression disposed on the inner surface of the flexible membrane in the perimeter portion, and extending around the second lens opening.

18. A head-mounted display device, comprising:
first and second optics modules, mounted to a frame and including a first lens and a second lens; and
a flexible membrane including:
a first lens opening accommodating the first lens,
a second lens opening accommodating the second lens,
at least one first deviating surface feature disposed around the first lens opening, and
at least one second deviating surface feature disposed around the second lens opening,
wherein the first and second optics modules are configured to move to change an interpupillary distance between the first and second lenses,
wherein the at least one first deviating surface feature is configured to change in shape in response to movement, of the first optics module, to change the interpupillary distance, and
wherein the at least one second deviating surface feature is configured to change in shape in response to movement, of the second optics module, to change the interpupillary distance.

19. The head-mounted display device of claim 18, wherein:
the at least one first deviating surface feature includes a first depression disposed on an inner surface of the flexible membrane in a perimeter portion of the flexible membrane, and extending around the first lens opening; and
the at least one second deviating surface feature includes a second depression disposed on the inner surface of the flexible membrane in the perimeter portion, and extending around the second lens opening.

20. The head-mounted display device of claim 18, wherein:
the at least one first deviating surface feature includes a first protruding pleat disposed on an inner surface of the flexible membrane, between the first lens opening and a central portion of the flexible membrane; and
the at least one second deviating surface feature includes a second protruding pleat disposed on the inner surface of the flexible membrane, between the second lens opening and the central portion of the flexible membrane.
